(19) United States
(12) Patent Application Publication
(10) Pub. No.: US 2002/0180156 A1
(43) Pub. Date: Dec. 5, 2002

(54) Axial sealing device for a turbomachine bearing

(76) Inventors: Quac Hung Tran, Liege (BE); Sebastien Rouelle, Bois et Borsu (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/158,205

(22) Filed: May 28, 2002

(30) Foreign Application Priority Data
May 30, 2001 (EP) 01870114.4-

(51) Int. Cl. F16J 15/34

(52) U.S. Cl. 277/352

(57) ABSTRACT

An axial sealing device for a turbomachine bearing, having a rotary ring fixed onto a sleeve of the shaft of the turbomachine, and a static ring linked to a fixed support by means of an anti-rotation blocking system and axially pushed against the rotary ring by means of springs. The static ring is formed by the assembly of at least two juxtaposed annular segments that form ducts at their junction for the injection of parietal air up to the interface of the two rings, which has lift slots.

### RELATED APPLICATIONS

This Application claims priority to European Patent Application No. 01870114.4, filed on May 30, 2001.

### BACKGROUND

1. Field of the Invention

The present invention relates to a seal for a turbomachine bearing and more especially to a seal of the axial type.

2. Description of the Related Art

The use of seals for turbomachine bearing chambers is well known per se. In turbomachines, the bearing generally comprises on the one hand a rolling bearing mounted between a sleeve fastened to a shaft of the turbomachine and a bearing support and on the other hand a seal support placed between an oil chamber for lubricating the rolling bearing and an air chamber of the turbomachine.

The function of the seal is to isolate the oil chamber from the air chamber, on the one hand to avoid oil leak from the oil chamber into the air chamber irrespective of the flight configurations, including the case of reverse thrust, and on the other hand to control air leak into the oil chamber.

There are essentially two types of seals, on the one hand radial seals, with or without contact, and on the other hand axial seals.

Examples of radial seals are in particular described in documents EP-A-0 818 607, U.S. Pat. No. 3,874,677, EP-A-0 387 122, EP-A-0 491 624 and EP-A-1 055 848.

Documents EP-A-0 967 424 and U.S. Pat. No. 4,398,730 describe examples of axial seals.

More particularly, document EP-A-0 967 424 describes a sealing device of the axial type of specific design. This known sealing device comprises on the one hand a rotary ring wedged on the above-mentioned sleeve of the turbomachine shaft on the side of the oil chamber and on the other hand a static carbon ring linked to a fixed support by means of an axial anti-rotation blocking system. The static ring is axially pushed against the rotary ring by means of springs. The radial face of the rotary ring that is applied against the static ring has lift slots so as to provide frictionless sealing between the respective radial faces of the two rings.

The use of axial seals or radial seals, with or without contact, greatly reduces air leaks into the oil chambers and consequently the oil consumption after passing through an oil separator.

However, with the currently known seals, the repercussions of the shaft unbalances are not controlled and considerable friction may rapidly result in wear. This obviously reduces the service life of such seals, which is a major drawback thereof. For certain applications indeed, and in particular in the case of aircraft turbojet engines, service lives of the order of a few thousand hours are markedly insufficient.

### SUMMARY OF THE INVENTION

The present invention aims to overcome the drawbacks of the known seals of the state of the art.

In particular, the present invention aims to control air leaks from the air chamber into the oil chamber while at the same time avoiding oil leaks from the oil chamber into the air chamber. More particularly, the invention aims to provide a seal of novel design that prevents such leaks in the case of aircraft turbojet engines, irrespective of the flight configurations, including the case of reverse thrust.

The present invention also aims to control the friction-induced heating of the seals and consequently to reduce their wear.

An additional aim of the invention is to provide a solution for increasing the service life of turbomachine seals.

More specifically, the present invention aims to reach these various objectives by improving the above-described sealing device of the axial type with reference to document EP-A-0 967 424.

The present invention relates to a sealing device of the axial type intended for a turbomachine bearing, said bearing comprising a bearing support, a rolling bearing, mounted between a sleeve fastened to a shaft of the turbomachine and said bearing support, and a seal support, said device separating an oil chamber of the rolling bearing from an air chamber of the turbomachine, said sealing device comprising on the one hand a rotary ring, preferably made of carbide or carbide-covered, mounted onto the part of the sleeve located on the side of the oil chamber, and on the other hand a static ring, preferably made of carbon, that is housed in a fixed support by means of an axial anti-rotation blocking system of said static ring on said support, and that is axially pushed against the rotary ring in its free state by means of springs, the rotary ring engaging with the static ring by means of lift slots machined on the radial face of said rotary ring in order to provide dynamic frictionless sealing in operation between the respective radial faces of said rings. According to the invention, said sealing device is characterized in that the static ring is formed by the assembly of at least two juxtaposed annular segments with tiered covering that form ducts at their junction for the injection of parietal air up to the radial face of said static ring.

In the sealing device according to the invention, the static ring engages with the rotary ring in order to provide the dynamic sealing between the oil chamber and the air chamber of the turbomachine. To this end, the rotary ring is centered without clamping on the sleeve fastened to the shaft and the static ring is mounted in a fixed support where it is retained and notably axially pushed in its free state and in operation by an anti-rotation blocking system. Springs push the static ring against the rotary ring so that their radial faces are applied against each other. The radial face of the rotary ring, which is applied against the static ring, has lift slots creating a pressure field. This lift effect, further reinforced by the fact that the ducts formed between the juxtaposed annular segments of the static ring allow the injection of parietal air in the slots of the rotary seal, advantageously allows to reduce or suppress friction between the carbon segments and the rotary ring while at the same time controlling the flow of air leak and granting the seal an extremely long service life.

Additional information regarding the rotary ring and the fixation of the static ring are available in document EP-A-0 967 424.

According to a preferred embodiment of the invention, the static ring advantageously comprises at least four and preferably six juxtaposed annular segments. This embodiment of the invention results in a better distribution of the parietal air.

In another particular embodiment of the sealing device according to the invention, semi-static sealing is obtained by compressing the annular segments of the static ring against its support by means of at least one annular expansion spring housed in a groove of said juxtaposed annular segments, this semi-static sealing comprising at least one slot directly machined at the periphery of the juxtaposed annular segments of the static ring.

Still according to the invention, the rotary ring is centered on the sleeve fastened to the shaft so as to be driven by the rotation of this shaft. In one advantageous embodiment, the rotary ring is centered on the sleeve without clamping by means of an elastic seal; its anti-rotation blocking on the sleeve and thus its drive on the shaft is provided by means of blocking pins and it is axially immobilized on the sleeve by means of an annular compression spring that engages with a system of controlled compression cartridges. In a particularly advantageous way, the annular compression spring comprises a washer of the Belleville type.

### BRIEF DESCRIPTION OF THE FIGURES

The characteristics and advantages of the invention will be more clearly understood with reference to the attached figures, in which:

FIG. 1 represents, on a cross-section view, a portion of turbomachine bearing comprising a sealing device according to the invention along a plane passing through the rotation axis of the shaft;

FIG. 2 shows an enlarged front view in perspective of the segmented carbon ring with its static sealings and the junction geometry between two segments;

FIG. 3 shows an enlarged rear view in perspective of the segmented carbon ring with its static sealings and the junction geometry between two segments;

FIG. 4 shows an exploded view of the rotary ring, the static ring and the support thereof.

In these figures, the same reference numerals designate identical components.

### DETAILED DESCRIPTION OF THE PREFERRED EMBODIMENTS

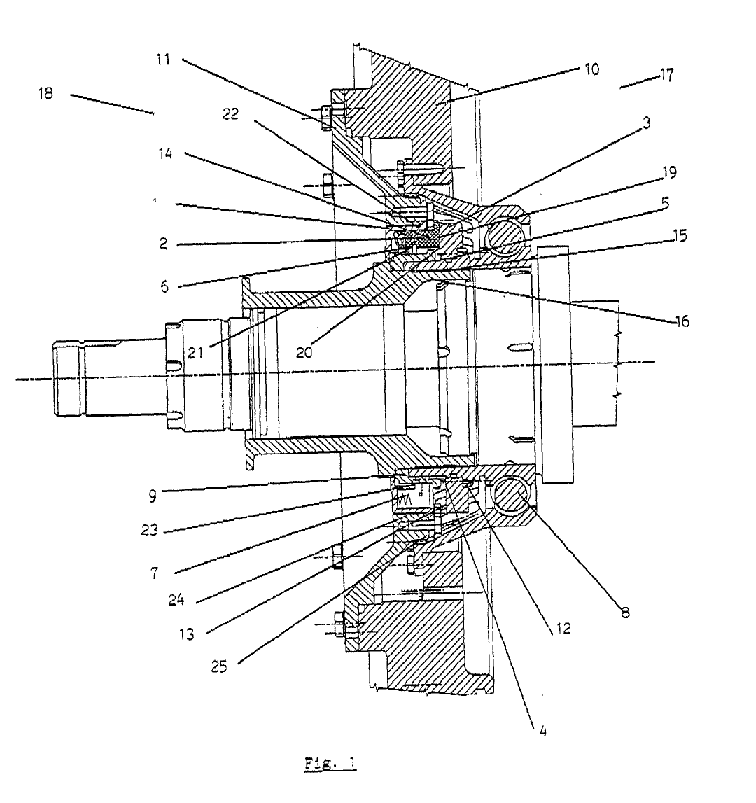

FIG. 1 shows a shaft 16 of the turbomachine fixed on a casing or bearing support 10 via a rolling bearing 8. Said support 10 forms a partition element between an air chamber 18 of the turbomachine and an oil chamber 17 for lubricating the rolling bearing 8 and the bearing. The sealing where the shaft 16 passes through the support 10 is provided by means of a sealing device of the axial type, according to the present invention.

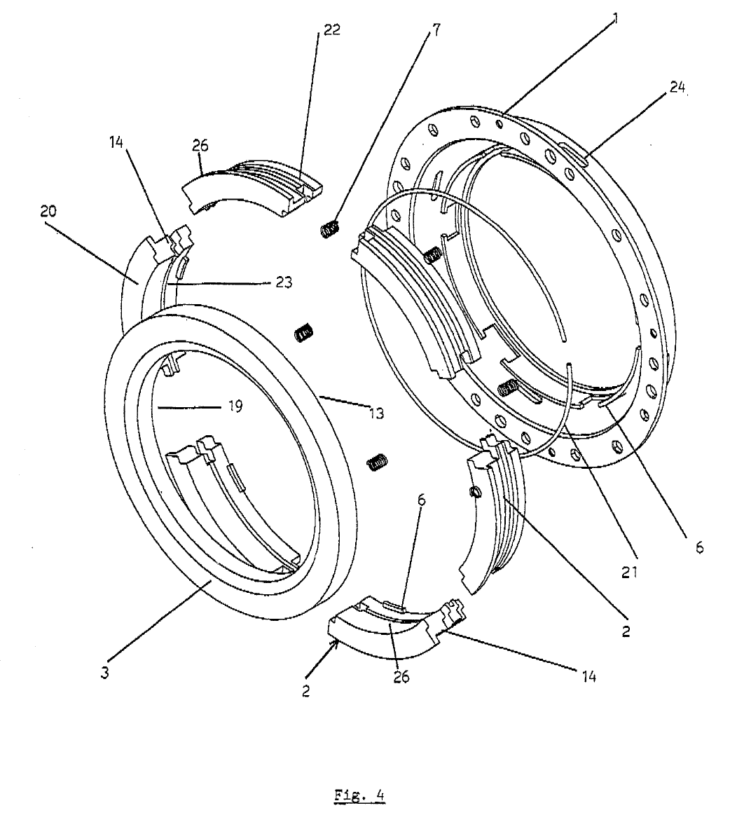

The sealing device comprises a rotary ring 3 (FIGS. 1 and 4), preferably made of carbide or carbide-covered, presenting slots that generate a lift effect on a radial contact surface 19 engaging with a surface 20 of a static ring of carbon segments.

The rotary ring 3 is centered but not clamped on a sleeve 15 fastened to the shaft 16. The rotary ring 3 is centered on the sleeve 15 by means of an elastic seal 5. This elastic seal allows the non-clamping centering of the rotary ring 3 and withstands the running temperatures. The rotary ring 3 is driven by the shaft 16 on the sleeve 15 by means of anti-rotation blocking pins 12 and is only maintained with respect to the axial movement by an annular compression spring 4, preferably a washer of the Belleville type, engaging with a system of controlled compression cartridges 9. This system ensures an appropriate compression of the annular spring of the Belleville type and thus axially immobilizes the rotary ring 3 on the sleeve 15.

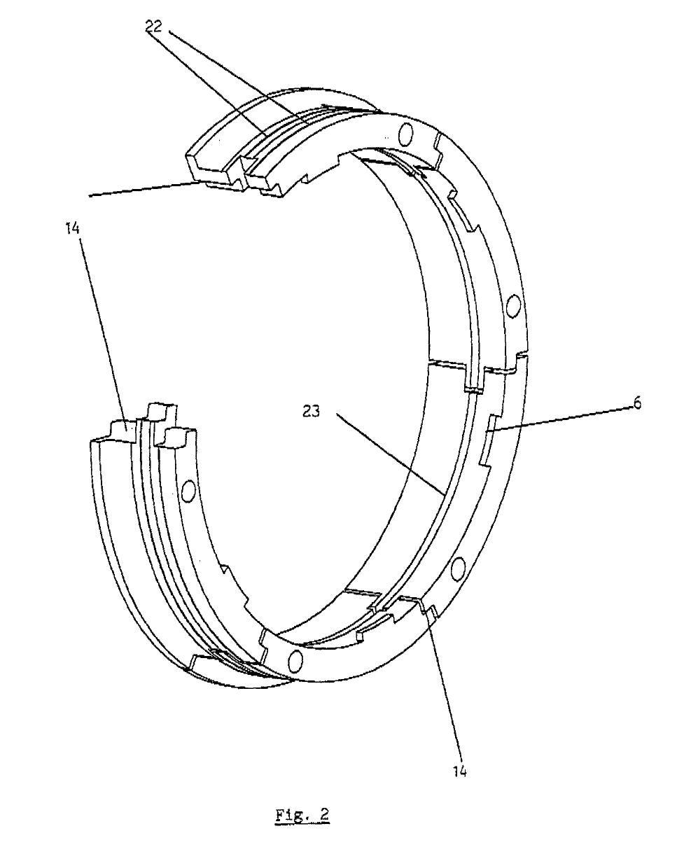

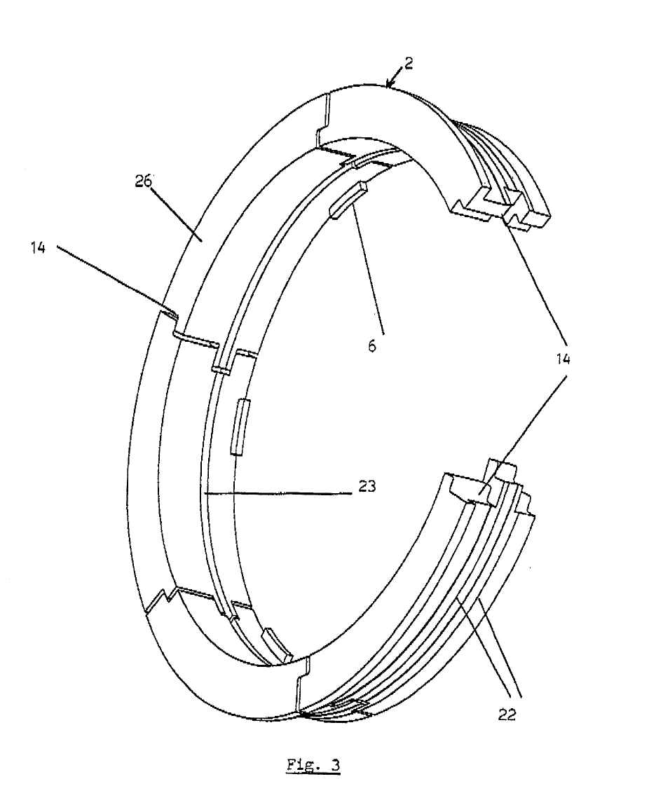

The seal also comprises a static ring designated overall by the reference numeral 2 (FIGS. 1, 2, 3 and 4). The static ring 2 is arranged about the sleeve 15, facing the rotary ring 3. In the preferred embodiment considered, the static ring 2 is formed by six annular carbon segments 26, which are juxtaposed with a tiered covering, together forming ducts 14 for the injection of parietal air.

The annular segments 26 of the static seal 2 are housed in an annular envelope 1 that serves as their support (FIG. 4). The envelope 1 is pierced with openings 24 for the evacuation of particles. It is fixed onto a support 11 that is itself fixed onto the support 10 and forms with it the partition element between the oil chamber 17 and the air chamber 18. The control of the compression of the carbon segment ring is ensured by a block 25. The annular segments 26 of the static ring 2 are held in their support 1 in their free state and in operation by means of an axial anti-rotation blocking system 6.

The semi-static sealing is ensured by slots 22, which are directly machined at the periphery of the juxtaposed annular segments 26 forming the static ring 2. The segments 26 are held against the annular support 1 by means of an annular expansion spring 21, housed in a groove 23 of said juxtaposed annular segments 26. This semi-static sealing is limited by the extreme operation temperatures of the carbon segment ring 2.

An axial load is provided by means of axial springs 7 in order to maintain the contact between the carbon segment ring 2 and the rotary ring 3 in its free state.

The rotary ring 3 comprises lift slots 13 (not shown in the drawings) on its radial contact face 19 facing the contact face 20 of the static ring 2. The lift effect generated at the interface of the contact surface 19 of the rotary ring 3 and the surface 20 of the carbon segment ring 2 is ensured by these lift slots 13 and the injection of parietal air through the junction ducts 14.

The air chamber 18 provides the pressurization at the air side of the carbon segment ring 2 and the oil chamber 17 provides the pressure at the oil side of the bearing chamber.

The segmented axial carbon seals with lift effect according to the present invention are technical improvements of the axial or radial carbon seals, with or without contact, of the state of the art. Indeed, the seals according to the invention draw several advantages from the co-operation between on the one hand a rotary ring comprising lift slots on its radial face and on the other hand a static ring formed by several juxtaposed segments, forming together ducts for the injection of parietal air. In particular, the following advantages are drawn:

lift effect furthered by the improvement of the parietal air distribution in the seal through the junction sections of the carbon segments;

very low air leak from the air chamber into the oil chamber (injection of parietal air);

very low oil consumption through the oil separator;

no oil leakage from the oil chamber into the air chamber, irrespective of the flight configurations, including the case of reverse thrust;

compatibility with the axial or radial movements of the shaft and bearing of the unbalances of the shaft without damages;

use at very high or very low temperatures (cryogenic);

few or no friction or wear and thus very long service life.

What is claimed is:

1. Axial sealing device for a turbomachine bearing, said bearing comprising a bearing support, a rolling bearing mounted between a sleeve fastened to a shaft of the turbomachine and said bearing support, and a seal support, said device separating an oil chamber of the rolling bearing from an air chamber of the turbomachine, said sealing device comprising on the one hand a rotary ring fixed onto the part of the sleeve on the side of the oil chamber, and on the other hand a static ring that is housed in a fixed support by means of an axial anti-rotation blocking system of said static ring on said support and that is axially pushed in its free state against the rotary ring by means of springs, the rotary ring engaging with the static ring by means of lift slots machined on the radial face of said rotary ring in order to provide dynamic frictionless sealing in operation between the respective radial faces of said rings, wherein the static ring is formed by the assembly of at least two juxtaposed annular segments with a tiered covering that form ducts at their junction for the injection of parietal air up to the radial face of said static ring.

2. Sealing device according to claim 1, wherein the static ring comprises at least four juxtaposed annular segments.

3. Sealing device according to claim 2, wherein the static ring comprises six juxtaposed annular segments.

4. Sealing device according to claim 3, wherein the blocking system of the static ring on the fixed support is designed such that said static ring is held on said fixed support without any contact with the shaft and axially blocked in its free state and in operation.

5. Sealing device according to claim 4, wherein semi-static sealing is obtained by compressing the annular segments of the static ring against the support by means of at least one annular expansion spring housed in a groove of said juxtaposed annular segments via at least one slot directly machined at the periphery of the juxtaposed annular segments of the static ring.

6. Sealing device according to claim 5, wherein the rotary ring is centered on the sleeve without clamping by means of an elastic seal, in that blocking pins provide the anti-rotation blocking of said rotary ring on the sleeve and its drive on the shaft and in that an annular compression spring, engaging with a system of controlled compression cartridges, axially immobilizes the rotary ring on the sleeve.

7. Sealing device according to claim 6, wherein the annular compression spring comprises a washer of the Belleville type.

8. Sealing device according to claim 7, wherein the static ring is made of carbon.

9. Sealing device according to claim 8, wherein the rotary ring is made of carbide or carbide-covered.
